(19) United States
(12) Patent Application Publication
(10) Pub. No.: US 2007/0165611 A1
(43) Pub. Date: Jul. 19, 2007

(54) Phone device for public switched telecommunication network and voice over internet protocol network

(75) Inventors: Rong-Chin Yang, Taipei City (TW); Chih-Hsin Chuang, Taipei City (TW); Che-Kang Lu, Taipei City (TW)

Correspondence Address: BIRCH STEWART KOLASCH & BIRCH, PO BOX 747, FALLS CHURCH, VA, 22040-0747, US

(73) Assignee: INVENTEC MULTIMEDIA & TELECOM CORPORATION

(21) Appl. No.: 11/328,239

(22) Filed: Jan. 10, 2006

(51) Int. Cl. H04L 12/66

(52) U.S. Cl. 370/356

(57) ABSTRACT

A phone device for the Public Switched Telecommunication Network (PSTN) and Voice over Internet Protocol (VoIP) network is provided. It is used to dial up through the PSTN and the VoIP network automatically or selectively, suitable for telecommunication networks of both inbound and outbound calls. A phone device includes a control circuit for coupling the analog phone module with the VoIP module, wherein the VoIP module is used for dial up through the PSTN, and a signal detection module is used to handle the operation timing between the VoIP network and the PSTN.

### BACKGROUND OF THE INVENTION

1. Field of Invention

The present invention relates to a phone system, and more particularly to a phone device suitable for the Public Switched Telecommunication Network (PSTN) and Voice over Internet Protocol (VOIP) network.

2. Related Art

The VoIP (Voice over Internet Protocol) is a protocol for transmitting sounds/images through an open network, providing calling services through a packet signal. Similar to transmitting information over Internet, making a call via the VoIP can save a lot in charges. However, the VoIP is restricted by many factors associated with the Internet, such as that the speech quality may be poor, the signals may be unstable, and the line may be disconnected.

The traditional phone is generally used in daily communication, wherein the analog phone is coupled to the Public Switched Telecommunication Network (PSTN) to provide calling services. Although the charge of the traditional phone is very high, it is not limited by many factors associated with the Internet, unlike VoIP. Moreover, the traditional phone is not influenced by power failure, and can still be used when the power is off.

Although VoIP has become more and more popular, it is also necessary for VoIP applications to support traditional calls to meet users' actual requirements. Only one phone is required for a user to make and receive VoIP and traditional calls, without buying both a VoIP phone and a traditional phone. It is convenient and also space-saving.

FIG. 1 is a block diagram of conventionally switching between the VoIP device and the conventional phone through a relay, wherein a relay 100 is used to carry out a simple switch between the FXS (Foreign eXchange Station) port 110 and the FXO (Foreign eXchange Office) port 120. Taking the household traditional phone as an example, it is connected with the switch of the telecommunication bureau by a phone line, wherein the FXS port 110 is the port connected to the phone, and the FXO port 120 is the port connected to the PSTN 130. In normal operation, the relay 100 is opened (the FXS port 110 is disconnected with the FXO port 120), and the VoIP phone 150 can be dialed up and connected to the VoIP network 160 through the VoIP module 140. The shortcoming of this design is in that the VoIP phone 150 only provides a bypass circuit, i.e., only when there has been a power failure is the relay 100 closed to connect the FXS port 110 with the FXO port 120, and the traditional call is made through the relay 100. Therefore, because of the hardware switching of the relay 100, communication through the VoIP network 160 and the PSTN 130 cannot be achieved simultaneously.

FIG. 2 is a block diagram of conventionally detecting the VoIP device and the traditional phone through a Direct Access Arrangement (DAA) device. The DAA device 170 is used to couple the VoIP module 140 with the PSTN 130, wherein dial up through both the VoIP network 160 and PSTN 130 can be achieved simultaneously without a traditional phone. However, when there is a power failure, the power supplied by the PSTN 130 only cannot meet the demands of the entire VoIP phone 150. Therefore, when there is a power failure, an additional traditional phone should be provided to make a call. Dial up cannot be achieved with a single phone when there is a power failure.

Accordingly, it has become a hot issue to design a phone device with a single phone for automatically switching between the PSTN and the VoIP network, without being affected by the power failure.

### SUMMARY OF THE INVENTION

In view of the above problems, a phone device for Public Switched Telecommunication Network (PSTN) and Voice over Internet Protocol (VOIP) network is provided, wherein the network call (VOIP network) or the traditional call (PSTN) is triggered and selected with a key or an audio input/output. The present invention includes a control circuit for coupling the analog phone module with the VoIP module, wherein the VoIP module is used for dial up through the PSTN, and a signal detection module is used to handle the operation timing between the VoIP network and the PSTN. For example, a predetermined function is provided, wherein when off the hook, the system is set to the PSTN, and the user may receive the inbound call of the PSTN. As the analog phone module is always connected to the VoIP network through the VoIP module, the analog phone module can still monitor the inbound call of the VoIP network. With the control circuit and the signal detection module, a phone system for automatically switching between the PSTN and the VoIP network can be achieved.

The detailed features and advantages of the present invention will be described in detail in the detailed description, enabling those skilled in the art to understand and implement the present invention accordingly. Any of the advantages and objects of the present invention can be understood from the description of the specifications, claims, and drawings herein.

Further scope of application of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description, given herein below for illustration only, which thus is not limitative of the present invention, and wherein:

FIG. 1 is a block diagram of conventionally switching between the VoIP device and the traditional phone though a relay;

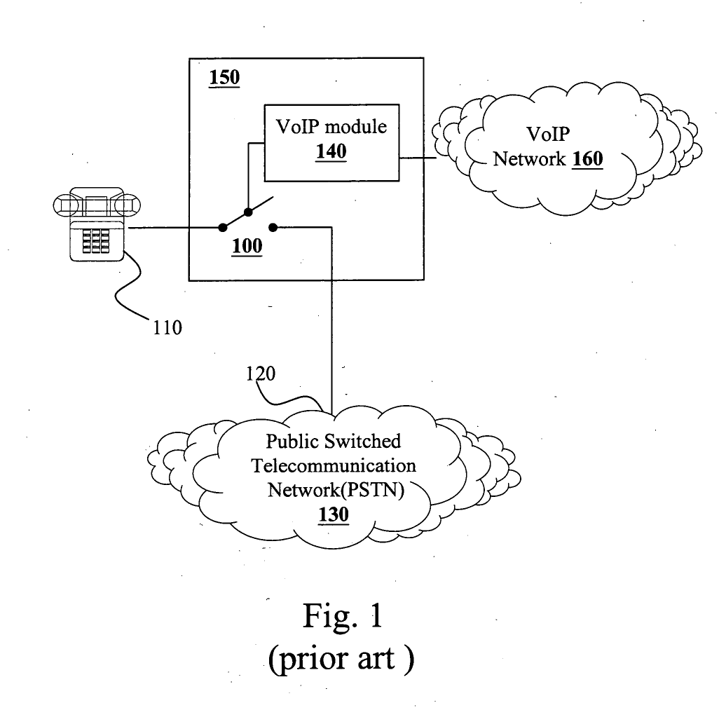

FIG. 2 is a block diagram of conventionally detecting the VoIP device and the traditional phone through a DAA device;

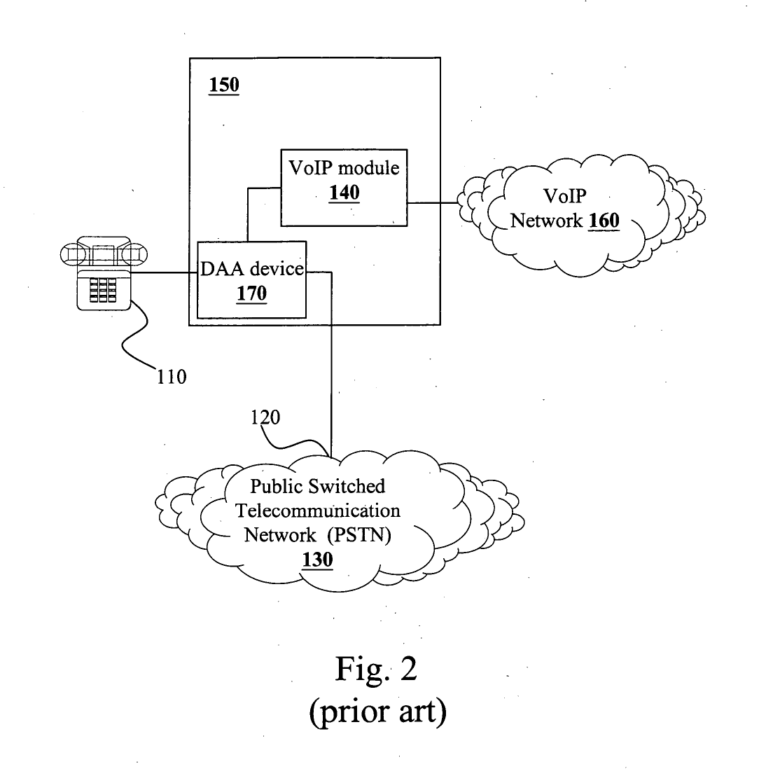

FIG. 3 is a systematic block diagram of a phone device for PSTN and VoIP network according to the present invention;

FIG. 4 is an inbound call processing flow according to a first embodiment of the present invention; and

FIG. 5 is an outbound call processing flow according to a second embodiment of the present invention.

### DETAILED DESCRIPTION OF THE INVENTION

The features and practice of the present invention are illustrated in great detail by the most preferred embodiments with reference to the accompanying drawings as follows.

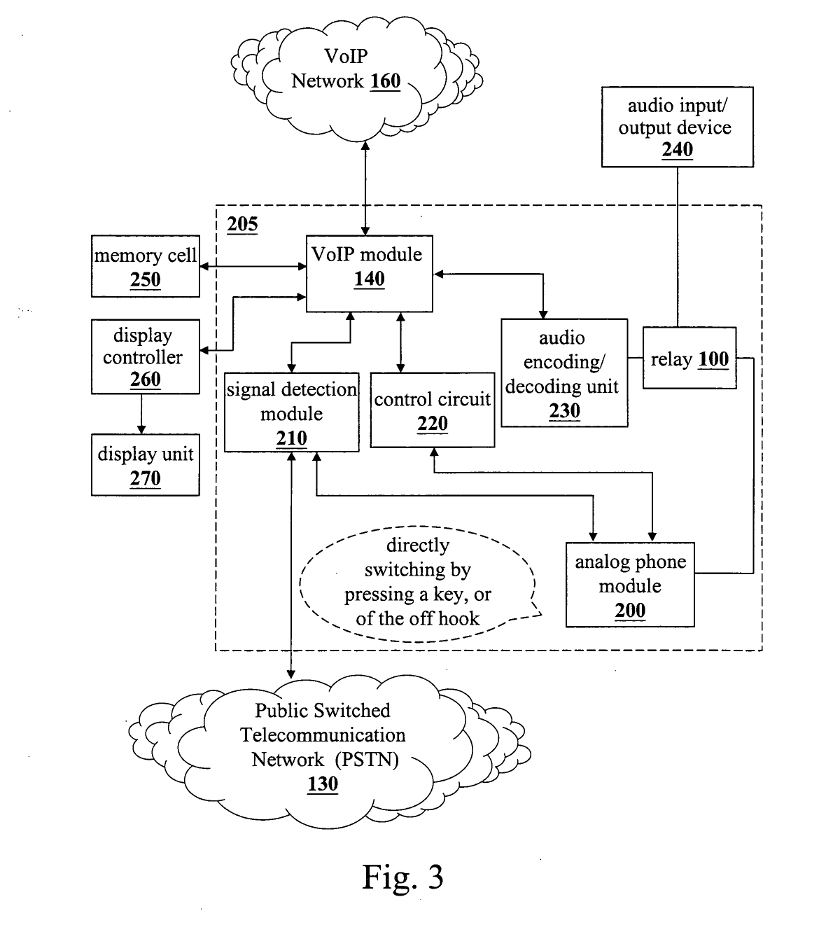

FIG. 3 is a systematic block diagram of a phone device for Public Switched Telecommunication Network (PSTN) and VoIP network according to the present invention. A switching device 205 suitable for PSTN and VoIP network (abbreviated as a switching device 205 below) to provide for dial up through the PSTN and the VoIP network is mainly included, and it can be applied to the telecommunication networks of both inbound and outbound calls. The switching device 205 further includes an analog phone module 200, a VoIP module 140, a signal detection module 210, a control circuit 220, an audio encoding/decoding unit 230, and a relay 100.

The VoIP module 140 mainly makes the outbound and inbound calls through the VoIP network 160 of this system. Since the VoIP module 140 is the conventional art, it will not be described here any more.

The signal detection module 210 is used to determine an inbound call signal belongs to the VoIP network 160 or the PSTN 130, and to detect the Off Hook signal, the dialed number, and the trigger signal of the function key.

The control circuit 220 is used to couple the analog phone module 200 with the VoIP module 140. The control circuit 220 is mainly used to switch the analog phone module 200 between the VoIP network 160 and the PSTN 130.

The audio encoding/decoding unit 230 is used to encode/decode the sounds of the VoIP network 160. With normal power supply, the audio encoding/decoding unit 230 is connected with the audio output/input device 240 through the relay 100, such that the audio output/input device 240 can output and input the sounds of the VoIP network 160.

The relay 100 couples with the audio encoding/decoding unit 230, the audio output/input device 240, and the analog phone module 200. When there is a power failure in the system, the phone peripheral settings (the audio output/input device 240) are automatically switched to the analog phone module 200 as soon as the relay 100 detects a power failure signal.

Of course, the VoIP network 160 should be combined with other modules to make a call, such as a memory cell 250, a display controller 260, and a display unit 270; wherein the memory cell 250 is used to access the parameter setting values and the voice; and the display controller 260 is used to receive the display message and the image signal to control the display states of the display unit 270, and these modules are all coupled to the VoIP module 140.

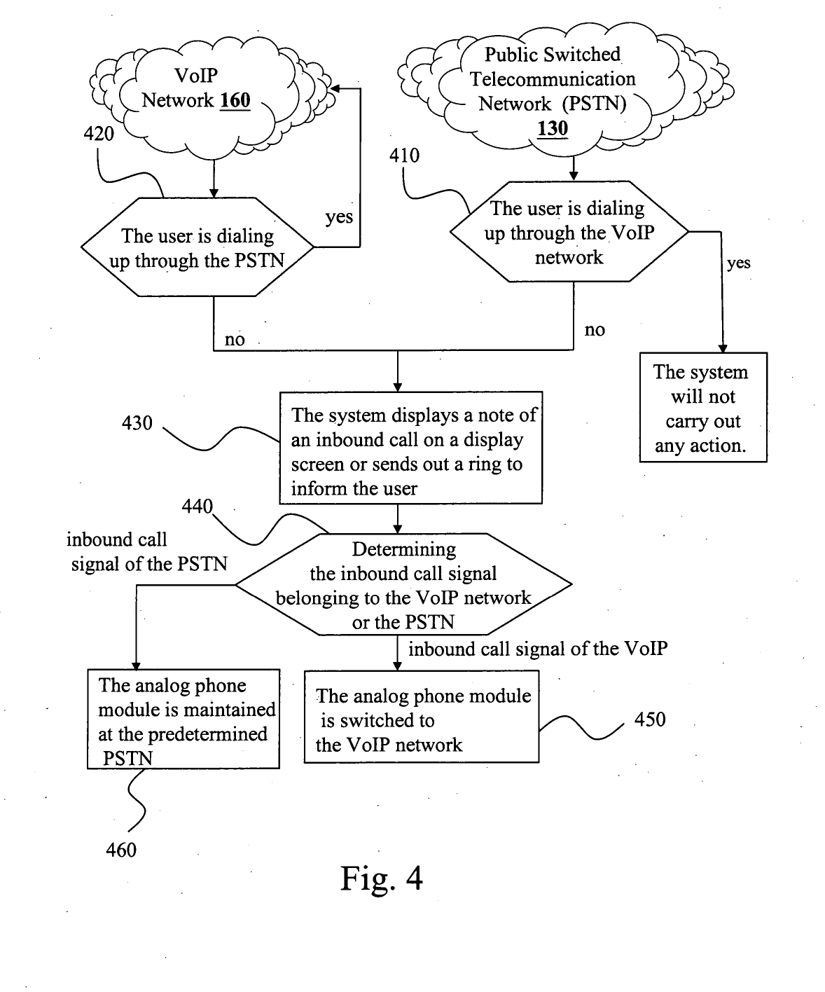

FIG. 4 is an inbound call processing flow according to a first embodiment of the present invention. This system is provided with a predetermined function, i.e., setting the analog phone module 200 to the PSTN 130, so as to receive the inbound call of the PSTN 130.

When the user is dialing up through the VoIP network 160 (Step 410), supposing there is an inbound call of the PSTN 130, the system will not carry out any action (because the circuit of the present system is so designed that it cannot feed back a busy signal to the port of an inbound call of the PSTN 130); and when the user is not using the VoIP network 160, the system will display a note of an inbound call on a display unit 270, or send out a ring to inform the user (Step 430).

When the user is dialing up through the PSTN 130 (Step 420), supposing there is an inbound call of the VoIP network 160, the system will refuse the inbound call; and when the user is not using the PSTN 130, the system will display a note of an inbound call on a display unit 270, or send out a ring to inform the user (Step 430).

When there is any inbound call (the VoIP network 160 or the PSTN 130), as soon as it is off-hook (alternatively, pressing a predetermined key of the system, such as a respond key or a speaker key, but not to limit the application scope of the present invention) when the user answers the phone, the signal detection module 210 determines the inbound call signal belongs to the VoIP network 160 or the PSTN 130 (Step 440). That is, if an inbound call signal of the VoIP network 160 is detected, the analog phone module 200 is switched to the VoIP network 160 (Step 450); if an inbound call signal of the PSTN 130 is detected, the analog phone module 200 is maintained at the predetermined PSTN 130 (Step 460).

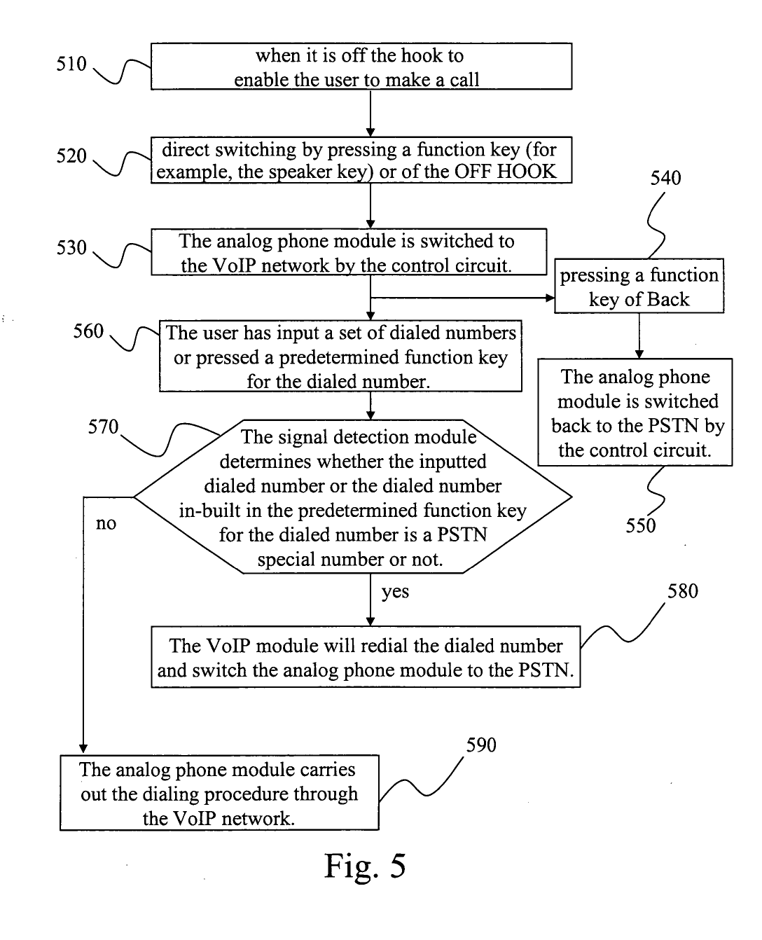

FIG. 5 is an outbound call processing flow according to a second embodiment of the present invention. When it is off hook to enable the user to make a call (Step 510), direct switching by pressing a function key (for example, the speaker key) or of the Off Hook (Step 520), but not to limit the application scope of the present invention, the analog phone module 200 is switched to the VoIP network 160 by the control circuit 220 (Step 530) as soon as the signal detection module 210 detects a trigger signal, to save the charge. In actual design, it is further switched by pressing a function key of Back (Step 540), and accordingly the desirable telecommunication network to be dialed is selectively provided to the user. Then the analog phone module 200 is switched back to the PSTN 130 by the control circuit 220 (Step 550). When the user selects the PSTN 130, the traditional PSTN 130 will be dialed up through the analog phone module 200; when the user does not select the PSTN 130, the VoIP network 160 will be dialed up through the VoIP module 140.

After the user has already input a group of dialed numbers or pressed a predetermined function key for the dialed number (Step 560), the signal detection module 210 determines whether the inputted dialed number or the dialed number in-built in the predetermined function key is a predetermined PSTN special number or not (for example, 119) within a time interval (Step 570). In view of the importance of the predetermined dialed number, the circumstance of unable to make a call due to special conditions (power failure) should not occur, thus, the important dialed numbers must be predetermined as the PSTN special numbers. When the signal detection module 210 detects that the dialed number is a predetermined PSTN special number, the VoIP module 140 will redial the dialed number, and switch the analog phone module 200 to the PSTN 130(Step 580); if the signal detection module 210 detects that the dialed number is not a predetermined PSTN special number, the analog phone module 200 carries out the dialing procedure through the VoIP network 160 (Step 590).

When there is a power failure in this system, upon detecting a power failure signal by the relay 100, the phone peripheral settings (audio output/input device 240, keys, a hook switch, and on the like) are automatically switched to the analog phone module 200 connected with the PSTN 130, and the traditional call is made with the power provided by the PSTN 130.

It is illustrated in particular that, the PSTN 130 is a predetermined dial up network in the above embodiments. Of course, in practice the predetermined telecommunication networks can be varied depending on the actual requirements (for example, the VoIP network 160). The selective function settings may be carried out through setting of the function key or factory defaults, but not to limit the scope of application of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A phone device for Public Switched Telecommunication Network (PSTN) and Voice over Internet Protocol (VoIP) network, comprising:
an analog phone module;
a VoIP module, making outbound and inbound calls of the VoIP network;
a signal detection module, for determining the inbound call signal belonging to the VoIP network or the PSTN, and detecting an Off Hook signal, a dialed number, and a trigger signal of a function key;
a control circuit, for coupling the analog phone module with the VoIP module, and switching the analog phone module between the VoIP network and the PSTN;
an audio encoding/decoding unit, for encoding and decoding sounds of the VoIP network; and
a relay, coupling the audio encoding/decoding unit with the analog phone module, and automatically switching the phone peripheral settings to the analog phone module as soon as a power failure signal is detected.

2. The phone device for PSTN and VoIP network as claimed in claim 1, further comprising an audio output/input device coupled with the relay for outputting and inputting the sounds of the VoIP network or the PSTN.

3. The phone device for PSTN and VoIP network as claimed in claim 1, further comprising a memory cell coupled with the VoIP module for accessing the parameter setting value and the voice.

4. The phone device for PSTN and VoIP network as claimed in claim 1, further comprising a display controller coupled with the VoIP module for receiving the display message and the image signal.

5. The phone device for PSTN and VoIP network as claimed in claim 4, further comprising a display unit coupled with the display controller to display the message and the image signal.

6. The phone device for PSTN and VoIP network as claimed in claim 1, wherein the dialed number is of a predetermined phone network.

7. The phone device for PSTN and VoIP network as claimed in claim 1, wherein the trigger signal of the function key provides the phone network for the user to choose and dial up.
